(19) United States
(12) Patent Application Publication
(10) Pub. No.: US 2026/0276826 A1
(43) Pub. Date: Sep. 17, 2026

(54) LASER RADAR TARGET DETECTION METHOD, SYSTEM, TERMINAL, AND STORAGE MEDIUM

(71) Applicant: Shenzhen University, Shenzhen (CN)

(72) Inventors: Qiang Li, Shenzhen (CN); Sijia Lai, Shenzhen (CN); Yiqiang Chen, Shenzhen (CN); Lei Huang, Shenzhen (CN); Peichang Zhang, Shenzhen (CN); Qiao Yan, Shenzhen (CN); Hongcheng Zhuang, Shenzhen (CN); Tao Liu, Shenzhen (CN)

(21) Appl. No.: 19/438,724

(22) Filed: Jan. 2, 2026

(30) Foreign Application Priority Data
Jan. 3, 2025 (CN) 202510007390.3

(51) Int. Cl. G01S 17/89; G06V 10/82; G06V 20/58

(52) U.S. Cl. CPC G01S 17/89; G06V 10/82; G06V 20/58

(57) ABSTRACT

The method comprises: acquiring target point cloud data and determining whether the total number of points in the target point cloud data exceeds a maximum point limit; when the total number of points in the target point cloud data exceeds the maximum point limit, performing weighted sampling on the target point cloud data using a point cloud sampling method based on the dynamic fusion of density and depth weights to obtain sampled point cloud data; performing voxelization on the sampled point cloud data to obtain voxelized point cloud data, processing the voxelized point cloud data using an improved feature encoding module, and outputting a target tensor; generating a pseudo-image based on the target tensor, extracting features from the pseudo-image using a two-dimensional convolutional neural network, and performing detection and regression on the extracted features using a detection head to obtain detection results.

### TECHNICAL FIELD

The disclosure relates to the technical field of autonomous driving, particularly to a laser radar target detection method, a system, a terminal, and storage medium.

### BACKGROUND

Among the widely applied 3D object detection algorithms in the field of autonomous driving currently, most are high detection accuracy, fast speed, and ease of deployment on mobile terminal computing devices. For instance, the PointPillars algorithm is a 3D object detection algorithm widely used in autonomous driving. Its core idea is to convert the 3D point cloud data generated by a laser radar into pseudo-images and then utilize a 2D convolutional neural network for feature extraction.

However, when these algorithms project 3D point cloud information onto a 2D plane, they inevitably lose some detailed features of objects, resulting in lower recognition accuracy for small targets (such as pedestrians and bicycles). Therefore, they have certain limitations in practical applications.

Consequently, there is still room for improvement and development in the existing technologies.

### SUMMARY

The primary objective of this disclosure is to provide a laser radar target detection method, a system, a terminal, and computer-readable storage medium, aimed at addressing the issue in existing technologies where current 3D object detection algorithms, when projecting 3D point cloud information onto a 2D plane, lose some detailed features of objects, resulting in lower recognition accuracy for small targets (such as pedestrians and bicycles) and thus having certain limitations in practical applications.

In order to achieve the aforementioned objective, this disclosure provides a laser radar target detection method, which comprises the following steps:
acquiring target point cloud data and determine whether the total number of points in the target point cloud data exceeds a maximum point limit;
when the total number of points in the target point cloud data exceeds the maximum point limit, performing weighted sampling on the target point cloud data using a point cloud sampling method based on the dynamic fusion of density and depth weights to obtain sampled point cloud data;
performing voxelization on the sampled point cloud data to obtain voxelized point cloud data, processing the voxelized point cloud data using an improved feature encoding module, and output a target tensor;
generating a pseudo-image based on the target tensor, extracting features from the pseudo-image using a 2D convolutional neural network, and performing detection and regression on the extracted features using a detection head to obtain detection results.

Optionally, the step of performing weighted sampling on the target point cloud data using the point cloud sampling method based on the dynamic fusion of density and depth weights to obtain sampled point cloud data specifically comprises:
calculating the depth of each point based on the spatial coordinates of each point in the target point cloud data, normalizing each depth to obtain a normalized depth value for each point;
calculating a distance threshold based on the depth of each point, calculating a depth score for each point based on the distance threshold and the normalized depth value of each point;
calculating the local density of each point based on the K-nearest neighbors algorithm, calculating a density score for each point based on the local density of each point;
calculating depth weights and density weights for each point based on the density score and depth score of each point;
fusing the depth score and density score of each point based on the depth weights and density weights of each point to obtain a fused score for each point, normalizing the fused score of each point to obtain a sampling probability for each point;
sampling a maximum point limit number of points from the target point cloud data based on the sampling probability of each point to constitute the sampled point cloud data.

Optionally, the step of calculating a distance threshold based on the depth of each point and calculating a depth score for each point based on the distance threshold and the normalized depth value of each point specifically, comprises:
obtaining the maximum and minimum depths from all points, calculate the distance threshold based on the maximum and minimum depths;
determining whether the depth of each point is less than the distance threshold, when it is, multiplying the normalized depth value of the point by a factor to obtain the depth score of the point;
when the depth of a point is not less than the distance threshold, configuring the normalized depth value of the point as the corresponding depth score.

Optionally, the step of calculating the local density of each point based on the K-nearest neighbors algorithm and calculating a density score for each point based on the local density of each point specifically, comprises:
calculating the average distance between each point and a preset number of nearest points based on the K-nearest neighbors algorithm to obtain the local density of each point;
obtaining the maximum and minimum local densities from all local densities;
normalizing the local density of each point based on the local density of each point, the maximum local density, and the minimum local density to obtain the density score of each point.

Optionally, the step of processing the voxelized point cloud data using an improved feature encoding module and outputting a target tensor specifically, comprises:
the feature encoding module centralizing each point based on the voxelized point cloud data to obtain centralized point coordinates and voxel centroid coordinates;
calculating the covariance matrix of the point cloud within each voxel based on the voxel centroid coordinates and each centralized point coordinate, performing eigenvalue decomposition on each covariance matrix to obtain the eigenvectors of each covariance matrix;
obtaining the normal vector corresponding to each point based on the eigenvectors of each covariance matrix, generating a 3D tensor based on the normal vector of each point and the voxelized point cloud data;
inputting the 3D tensor into a point cloud feature enhancement module based on a self-attention mechanism for linear transformation to obtain and outputting a target tensor.

Optionally, the step of inputting the 3D tensor into a point cloud feature enhancement module based on a self-attention mechanism for linear transformation to obtain and output a target tensor specifically comprises:
the point cloud feature enhancement module based on a self-attention mechanism performing three linear transformations on the 3D tensor and performs residual connection on the results of the second and third linear transformations to obtain linear features, wherein normalization is performed after each linear transformation, and nonlinearity is introduced based on an activation function to obtain the result of the linear transformation, the result of the first linear transformation is input into the second linear transformation after passing through a self-attention mechanism, and the result of the second linear transformation is input into the third linear transformation;
obtaining the maximum value from the linear features, using the maximum value from the linear features as the target tensor and output it.

Optionally, after the step of acquiring target point cloud data and determining whether the total number of points in the target point cloud data exceeds a maximum point limit, the following step is further included:
when the total number of points in the target point cloud data does not exceed the maximum point limit, performing voxelization on the current sampled point cloud data to obtain the voxelized point cloud data at this time, processing the corresponding voxelized point cloud data using an improved feature encoding module, and output the corresponding target tensor;
extracting features from the current target tensor using a 2D convolutional neural network, and performing detection and regression on the extracted features using a detection head to obtain the corresponding detection results.

Furthermore, in order to achieve the aforementioned objective, this disclosure also provides a laser radar target detection system, wherein the laser radar target detection system comprises:
a judgment module configured to acquire target point cloud data and determining whether the total number of points in the target point cloud data exceeds a maximum point limit;
a sampling module configured to perform weighted sampling on the target point cloud data using a point cloud sampling method based on the dynamic fusion of density and depth weights when the total number of points in the target point cloud data exceeds the maximum point limit to obtain sampled point cloud data;
an output module configured to perform voxelization on the sampled point cloud data to obtain voxelized point cloud data, process the voxelized point cloud data using an improved feature encoding module, and output a target tensor;
a result generation module configured to generate a pseudo-image based on the target tensor, extract features from the pseudo-image using a 2D convolutional neural network, and perform detection and regression on the extracted features using a detection head to obtain detection results.

Furthermore, in order to achieve the aforementioned objective, this disclosure also provides a terminal, wherein the terminal comprises: a memory, a processor, and a laser radar target detection program stored on the memory and executable on the processor, the laser radar target detection program, when executed by the processor, implements the steps of the aforementioned laser radar target detection method.

Furthermore, in order to achieve the aforementioned objective, this disclosure also provides a computer-readable storage medium, wherein the computer-readable storage medium stores a laser radar target detection program, the laser radar target detection program, when executed by a processor, implements the steps of the aforementioned laser radar target detection method.

In this disclosure, target point cloud data is acquired, and it is determined whether the total number of points in the target point cloud data exceeds a maximum point limit; when the total number of points in the target point cloud data exceeds the maximum point limit, weighted sampling is performed on the target point cloud data using a point cloud sampling method based on the dynamic fusion of density and depth weights to obtain sampled point cloud data; voxelization is performed on the sampled point cloud data to obtain voxelized point cloud data, the voxelized point cloud data is processed using an improved feature encoding module, and a target tensor is output; a pseudo-image is generated based on the target tensor, features are extracted from the pseudo-image using a 2D convolutional neural network, and detection and regression are performed on the extracted features using a detection head to obtain detection results. This disclosure, through a point cloud sampling method based on the dynamic fusion of density and depth weights, combines the depth information and density distribution of point clouds to dynamically adjust sampling weights, addressing the issue of easily ignoring information in sparse regions in current sampling methods, thereby significantly improving the representativeness and processing efficiency of point cloud data; simultaneously, this disclosure improves the feature encoding module, thereby enhancing the overall algorithm's accuracy and robustness in object recognition and segmentation tasks.

### BRIEF DESCRIPTION OF THE DRAWINGS

FIG. 1 is a flowchart of a preferred embodiment of the laser radar target detection method of the present disclosure;

FIG. 2 is a schematic diagram of an improved feature encoding module in the laser radar target detection method of the present disclosure;

FIG. 3 is a structural schematic diagram of a point cloud feature enhancement module based on a self-attention mechanism in the laser radar target detection method of the present disclosure;

FIG. 4 is a schematic diagram of an implementation process in the laser radar target detection method of the present disclosure;

FIG. 5 is a structural diagram of a preferred embodiment of the laser radar target detection system of the present disclosure; and

FIG. 6 is a structural diagram of a preferred embodiment of the terminal of the present disclosure.

### DETAILED DESCRIPTION

In order to make the objectives, technical solutions, and advantages of the present disclosure clearer and more explicit, the following provides a further detailed description of the present disclosure with reference to the accompanying drawings and by presenting embodiments. It should be understood that the specific embodiments described herein are merely used to explain the present disclosure and are not intended to limit it.

Currently, among the three-dimensional (3D) object detection algorithms widely applied in the field of autonomous driving, most are high detection accuracy, fast speed, and ease of deployment on mobile terminal computing devices. For example, the PointPillars algorithm is a widely used 3D object detection algorithm in the autonomous driving field. Its core idea is to convert the 3D point cloud data generated by laser radar into pseudo-images and then use a two-dimensional (2D) convolutional neural network for feature extraction. Specifically, it first performs pillarization processing on the point cloud in 3D space, that is, dividing it into evenly spaced 3D cylindrical spaces (Pillars), and calculating features such as the average height and the number of point clouds in each pillar to generate a 2D pseudo-image. Subsequently, a 2D convolutional neural network is used to extract features from the pseudo-image for object detection and classification. The advantage of this feature extraction method is that it replaces 3D convolutions with 2D convolutions, significantly improving detection speed while maintaining relatively good accuracy, which can meet the real-time performance requirements of autonomous driving scenarios. However, these algorithms project 3D point cloud information onto a 2D plane, which results in the loss of some detailed features of objects, leading to lower recognition accuracy for small objects (such as pedestrians and bicycles). Therefore, they have certain limitations in practical applications.

In order to address one or more of the above issues, the present disclosure obtains target point cloud data and determines whether the total number of points in the target point cloud data exceeds a maximum point limit. When the total number of points in the target point cloud data exceeds the maximum point limit, weighted sampling is performed on the target point cloud data using a point cloud sampling method based on the dynamic fusion of density and depth weights, resulting in sampled point cloud data. The sampled point cloud data is then pillarized to obtain pillarized point cloud data. The pillarized point cloud data is processed by an improved feature encoding module to output a target tensor. A pseudo-image is generated based on the target tensor, and features are extracted from the pseudo-image using a 2D convolutional neural network. A detection head is employed to detect and regress the extracted features, resulting in detection results.

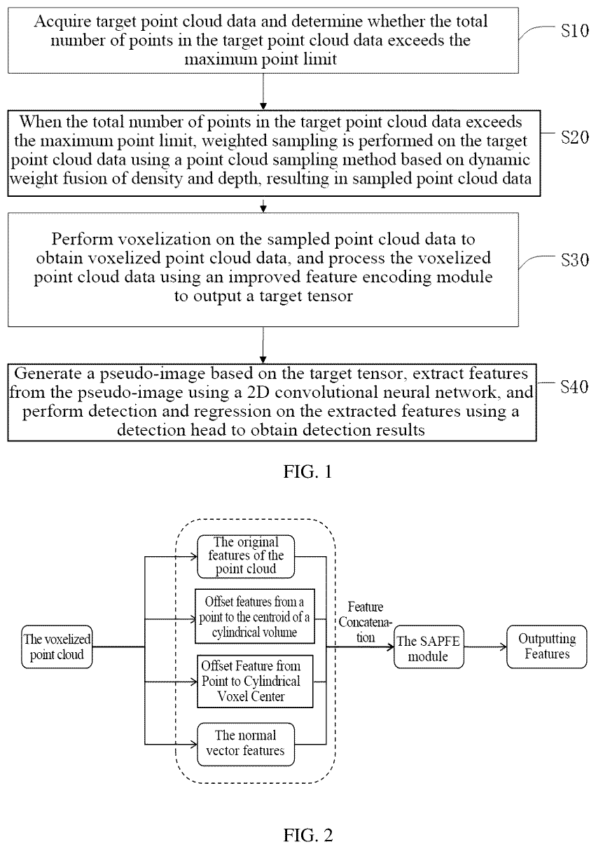

The laser radar target detection method described in a preferred embodiment of the present disclosure, as shown in FIG. 1, comprises the following steps.

Step S10: target point cloud data is acquired and it is determined whether the total number of points in the target point cloud data exceeds the maximum point limit.

It should be noted that in this disclosure, to detect laser radar targets, it is specifically necessary to acquire corresponding target point cloud data, thereby enabling the detection of laser radar targets through the target point cloud data.

Specifically, in this disclosure, a frame of target point cloud data P composed of N points is represented as P={p₁,p₂,p₃,p₄ . . . . p_{N}}, wherein each point is represented as pᵢ={xᵢ,yᵢ,zᵢ,mᵢ}. Here, xᵢ,yᵢ and zᵢ denote the coordinates of the point, mᵢ represents the reflectivity of the point, i indicates the serial number of a certain point in the point cloud, and p₁, p₂, p₃, p₄, and p_{N} respectively represent the 1st, 2nd, 3rd, 4th, and Nth points in the target point cloud data. For the target point cloud data, it is determined whether the total number of points exceeds the maximum point limit. When N exceeds the maximum point limit k, a point cloud sampling method based on dynamic weight fusion of density and distance is employed for sampling.

Step S20: when the total number of points in the target point cloud data exceeds the maximum point limit, weighted sampling is performed on the target point cloud data using a point cloud sampling method based on dynamic weight fusion of density and depth, resulting in sampled point cloud data.

Specifically, when the total number of points in the target point cloud data exceeds the maximum point limit, in order to address the issue of easily overlooking information in sparse regions, thereby significantly enhancing the representativeness and processing efficiency of the point cloud data, this disclosure employs a point cloud sampling method based on dynamic weight fusion of density and depth to perform weighted sampling on the target point cloud data, thereby obtaining sampled point cloud data.

Furthermore, the step of performing weighted sampling on the target point cloud data using a point cloud sampling method based on dynamic weight fusion of density and depth to obtain sampled point cloud data specifically comprises the following:
calculating the depth of each point based on the spatial coordinates of each point in the target point cloud data, normalizing each depth value to obtain the normalized depth value for each point;
calculating a distance threshold based on the depth of each point, and then computing the depth score for each point based on the distance threshold and the normalized depth value of each point;
calculating the local density of each point using the K-nearest neighbors algorithm, and then computing the density score for each point based on its local density;
calculating the depth weight and density weight for each point based on its density score and depth score;
fusing the depth score and density score of each point based on its depth weight and density weight to obtain a fused score for each point, normalizing the fused score of each point to obtain the sampling probability for each point;
sampling a number of points up to the maximum point limit from the target point cloud data based on the sampling probability of each point to form the sampled point cloud data.

Specifically, in this disclosure, the depth dᵢ of each point is first calculated based on the spatial coordinates of each point in the target point cloud data, which represents the Euclidean distance from the laser radar to each point. The calculation process is expressed as:

$${d}_{i} = \sqrt{( {x}_{i}^{2} + {y}_{i}^{2} + {z}_{i}^{2} )} ;$$

where (xᵢ, yᵢ, zᵢ) represents the spatial coordinates of the point.

Subsequently, the depth value dᵢ is normalized, with a larger corresponding depth resulting in a higher sampling probability. The normalization formula is shown as:

$${d}_{i}^{′} = \frac{{d}_{i} - {d}_{m i n}}{{d}_{m ax} - {d}_{m i n}} ;$$

where d′ᵢ represents the normalized depth value of point i, and dₘᵢₙ and dₘₐₓ represent the minimum and maximum depth values, respectively, which can be obtained after calculating the depth of each point.

Furthermore, the step of calculating a distance threshold based on the depth of each point and computing the depth score for each point based on the distance threshold and the normalized depth value of each point specifically comprises the following:
obtaining the maximum and minimum depth values from all points and calculating the distance threshold based on these maximum and minimum depth values;
   determining whether the depth of each point is less than the distance threshold, when the depth of each point is less than the distance threshold, multiplying the normalized depth value of the point by a factor to obtain its depth score;
   When the depth of a point is not less than the distance threshold, configuring its normalized depth value as its corresponding depth score.

After calculating the normalized depth value for each point, the depth score for each point is correspondingly calculated. The distance threshold e is first calculated using the maximum and minimum depth values, with the calculation method being:

$$θ = {d}_{m i n} + 0.5 \cdot ( {d}_{m ax} - {d}_{m i n} ) ;$$

Subsequently, for each point, it is determined whether its depth is less than the distance threshold. If its depth dᵢ satisfies dᵢ<θ, its depth score is multiplied by a factor of 1.5. After adjustment, the depth score sᵢ^{depth} for each point is obtained as:

$${s}_{i}^{depth} = \{ \begin{matrix}1.5 \cdot {d}_{i}^{′} & {d}_{i} < θ \\ {d}_{i}^{′} & {d}_{i} \geq θ\end{matrix} .$$

Furthermore, the step of calculating the local density of each point based on the K-nearest neighbors algorithm and computing the density score for each point based on its local density specifically comprises the following:
calculating the average distance between each point and its K-nearest neighbors using the K-nearest neighbors algorithm to obtain the local density of each point;
   obtaining the maximum and minimum local density values from all local densities;
   normalizing the local density of each point based on its local density, the maximum local density, and the minimum local density to obtain the density score for each point.

Specifically, after calculating the depth score for each point, the density score for each point is correspondingly calculated. This is achieved by using the K-nearest neighbors algorithm (KNN) to estimate the local density of each point, i.e., calculating the average distance between each point and its 10 nearest neighbors. The calculation formula is as follows:

$${ρ}_{i} = \frac{1}{10} {\sum }_{j = 1}^{10} dist ( i , j ) ;$$

where ρᵢ represents the local density of the i point, and dist(i,j) represents the Euclidean distance between point i and point j. After obtaining the local density of each point, the maximum and minimum local density values are correspondingly obtained.

The local density of each point is normalized based on its local density, the maximum local density, and the minimum local density to obtain the corresponding density score, which increases the sampling probability of points in sparse regions. The normalization process is represented as:

$${s}_{i}^{density} = \frac{{ρ}_{i} - {ρ}_{m i n}}{{ρ}_{m ax} - {ρ}_{m i n}} ;$$

where Sᵢ^{density} is the density score of point i, and ρₘᵢₙ and ρₘₐₓ are the minimum and maximum local density values, respectively.

Subsequently, based on the density score and depth score of each point, the depth weight and density weight of each point are calculated as follows:

$${w}_{1} = \frac{Var ( {s}^{depth} )}{Var ( {s}^{depth} ) + Var ( {s}^{density} )} ;$$

$${w}_{2} = \frac{Var ( {s}^{density} )}{Var ( {s}^{depth} ) + Var ( {s}^{density} )} ;$$

where wᵢ is the depth weight, w₂ is the density weight, Var(s^{depth}) is the variance of the depth scores, and Var(s^{density}) is the variance of the density scores.

The depth score and density score of each point are fused using adaptive weights to obtain the fused score Sᵢ^{combined} for each point:

$${s}_{i}^{combined} = {w}_{1} \cdot {s}_{i}^{depth} + {w}_{2} \cdot {s}_{i}^{density} ;$$

the fused score sᵢ^{combined} is normalized to obtain the sampling probability eᵢ for each point:

$${e}_{i} = \frac{{s}_{i}^{combined}}{{\sum }_{j = 1}^{N} {s}_{j}^{combined}} ;$$

Sampling is performed according to the sampling probability, i.e., k points are randomly sampled without replacement from the target point cloud data P according to the probability distribution e. The sampling process S can be represented as:

$$S = \{ {s}_{1} , {s}_{2} , … , {s}_{k} \} , {s}_{i} ∈ p ;$$

Where s₁, s₂ and sₖ represent the 1st, 2nd, and kth sampled points, respectively, and sᵢ represents a sampled point. The specific sampling rule is shown as:

$${P}_{r} ( {s}_{i} = {p}_{j} ) = {e}_{j} , j ∈ \{ 1 , 2 , … , N \} ;$$

Where Pᵣ represents the probability that the ith point is point pⱼ, eⱼ represents the sampling probability of the jth point, and j represents the serial number of a point in the point cloud.

After sampling, the sampled point cloud data is obtained, which is represented as:

$${P}_{new} = \{ {p}_{j} \vert j ∈ choice \} ;$$

where choice represents the set of indices corresponding to pⱼ in the sampled point cloud data P_{new}.

Step S30: voxelization is performed on the sampled point cloud data to obtain voxelized point cloud data, and the voxelized point cloud data is processed using an improved feature encoding module to output a target tensor.

It should be noted that after obtaining the sampled point cloud data by sampling the target point cloud data using a point cloud sampling method based on dynamic weight fusion of density and depth, to enhance the accuracy and robustness of the overall algorithm in object recognition and segmentation tasks, this disclosure improves the feature encoding module. It proposes incorporating normal vector features into the feature encoding module and designs a Self-Attention-Based Point Feature Enhancement Module (SAPFE).

Specifically, the sampled point cloud data is first voxelized, that is, the sampled point cloud data P_{new} is divided into L equally sized voxels in three-dimensional space. For each voxel, the improved feature encoding module expands the dimensions of each point within it, obtaining a corresponding representation for each point after dimension expansion: P′ᵢ={xᵢ, yᵢ, zᵢ, mᵢ, x_{c}, y_{c}, z_{c}, xₚ, yₚ, zₚ, xᵥ, yᵥ, zᵥ}. Here, x_{c}, y_{c}, z_{c} represent the offsets from the point to the centroid of the voxel, xₚ, yₚ, zₚ represent the offsets from the point to the center of the voxel, and xᵥ,yᵥ, zᵥ represent the components of the normal vector u of the point. The normal vector u is obtained by calculating the covariance matrix of the point cloud within each voxel and then performing eigenvalue decomposition on it.

Furthermore, the step of processing the voxelized point cloud data using the improved feature encoding module to output the target tensor specifically comprises the following.

The feature encoding module centers each point based on the voxelized point cloud data, obtaining the centered point coordinates and the voxel centroid coordinates.

Based on the voxel centroid coordinates and each centered point coordinate, the covariance matrix of the point cloud within each voxel is calculated, and eigenvalue decomposition is performed on each covariance matrix to obtain the eigenvectors of each covariance matrix.

Based on the eigenvectors of each covariance matrix, the corresponding normal vector for each point is obtained. Based on the normal vectors of each point and the voxelized point cloud data, a three-dimensional tensor is generated.

The three-dimensional tensor is input into the Self-Attention-Based Point Feature Enhancement Module for linear transformation, and the target tensor is obtained and output.

Specifically, as shown in FIG. 2, it illustrates the improved feature encoding module. In this module, by centering each point, the centered point coordinates and the voxel centroid coordinates can be obtained, thereby calculating the corresponding normal vectors. The offsets from each point to the voxel centroid are calculated based on the voxel centroid coordinates, and the geometric center of the voxel is acquired. Based on the geometric center of the voxel, the offsets from each point to the voxel center can be determined. By combining the original features of the point cloud, the normal vectors, the offsets from each point to the voxel centroid, and the offsets from each point to the voxel center, the representation of each point after dimension expansion can be obtained, which is then input into the SAPFE module.

Here, centering refers to subtracting the voxel centroid coordinates from the coordinates of each point, which can be expressed as:

$$\overline{q} = \frac{1}{M} {\sum }_{i = 1}^{M} {q}_{j} ;$$

$${q}_{i}^{′} = {q}_{i} - \overline{q} ;$$

where qᵢ is the three-dimensional coordinate vector of th ith point, i.e., (xᵢ,yᵢ,zᵢ); q̅ is the three-dimensional coordinate vector of the voxel centroid, i.e., the voxel centroid coordinates (x̅,y̅,z̅); M is the number of points in the voxel; q′ᵢ is the coordinates of the centered point, i.e., the centered point coordinates (xᵢ−x̅,yᵢ−y̅,z₁−z̅).

Based on the voxel centroid coordinates and each centered point coordinate, the covariance matrix of the point cloud within each voxel is calculated. The covariance matrix A is a matrix used to describe the dispersion of the point cloud in different directions, measuring the joint variation of the three-dimensional coordinates of the point cloud in different directions. Specifically, the formula for the covariance matrix A is:

$$A = {( {q}_{i}^{′} - \overline{q} )}^{T} ( {q}_{i}^{′} - \overline{q} ) .$$

Subsequently, by performing eigenvalue decomposition on the covariance matrix, the dispersion of the point cloud in different directions can be obtained. The relationship between eigenvalues and eigenvectors is as follows:

$$A \cdot {r}_{i} = {λ}_{i} \cdot {r}_{i} ;$$

where λ, is the eigenvalue of the covariance matrix, representing the variance magnitude of the point cloud in that direction; rᵢ is the eigenvector of the covariance matrix, representing the distribution direction of the point cloud in that direction.

By using the eigenvectors, the normal vector u is selected, where u=r₁, and r₁ is the eigenvector corresponding to the smallest eigenvalue of the covariance matrix. Thus, u can be expressed as u={xᵥ,yᵥ,zᵥ}.

After all feature calculations are completed, a three-dimensional tensor T₁ with dimensions (L, M, 13) is obtained, where L represents the number of voxels, and M represents the number of point clouds contained in each voxel. To enhance the point cloud features, the Self-Attention-Based Point Feature Enhancement Module is used to process this tensor.

Furthermore, the step of inputting the three-dimensional tensor into the Self-Attention-Based Point Feature Enhancement Module for linear transformation to obtain and output the target tensor specifically comprises the following.

The Self-Attention-Based Point Feature Enhancement Module performs three linear transformations on the three-dimensional tensor and performs residual connection on the results of the second and third linear transformations to obtain linear features. Normalization is performed after each linear transformation, and nonlinearity is introduced based on an activation function to obtain the result of that linear transformation. The result of the first linear transformation is passed through a self-attention mechanism and then configured as the input for the second linear transformation, and the result of the second linear transformation is used as the input for the third linear transformation;

The maximum value in the linear features is obtained, and this maximum value is used as the target tensor and output.

Specifically, as shown in FIG. 3. Each voxel corresponds to a batch and undergoes linear transformations sequentially in Linear Layer 1, Linear Layer 2, and Linear Layer 3. First, the first linear transformation is performed, calculating the first linear feature K₁=T₁γ₁+b₁, where γ₁ and b₁ are the weight and bias term of the linear transformation, respectively. Subsequently, K₁ is normalized to adjust the data distribution, and then the ReLU activation function is applied to introduce nonlinearity into the network, yielding the result of the first linear transformation, K′₁. Afterwards, this disclosure introduces a self-attention mechanism to calculate attention weights a, which are then applied to K′₁, resulting in weighted features F=K′⊙a, where ⊙ denotes element-wise multiplication. The second linear transformation is performed on the weighted features F, calculating the second linear feature K₂=Fγ₂+b₂, which is then normalized and subjected to the ReLU activation function to obtain the result of the second linear transformation, K′₂. The third linear transformation is executed to obtain the third linear feature K₃=K′₂γ₃+b₃, which is normalized and processed with the ReLU activation function to yield the result of the third linear transformation,K′₃. To introduce residual connections, this disclosure adds K′₂ and K′₃ to obtain linear features D=K′₂+K′₃. Subsequently, the maximum value Dₘₐₓ in the linear features is extracted through max pooling and used as the network's output, i.e., the target tensor. At this point, the output is a target tensor with dimensions (L, 64), where L represents the number of voxels.

Step S40: a pseudo-image is generated based on the target tensor, extract features are extracted from the pseudo-image using a 2D convolutional neural network, and detection and regression are performed on the extracted features using a detection head to obtain detection results.

Specifically, after obtaining the target tensor, to apply a 2D convolutional neural network (2D CNN) to the point cloud data, the voxel features are projected back to their original positions based on the coordinates of the voxel centers in the target tensor, resulting in a corresponding pseudo-image. Subsequently, a 2D CNN is used to extract features from the pseudo-image, and the corresponding detection head is employed to perform detection and regression on the extracted features, yielding detection results.

In addition, the process of acquiring target point cloud data, determining whether the total number of points in the target point cloud data exceeds the maximum point limit, and the subsequent steps also comprise the following.

When the total number of points in the target point cloud data does not exceed the maximum point limit, the current sampled point cloud data is voxelized to obtain the current voxelized point cloud data. The improved feature encoding module is then used to process the corresponding voxelized point cloud data, outputting the corresponding target tensor.

Features are extracted from the current target tensor using a 2D CNN, and detection and regression are performed on the extracted features using a detection head to obtain the corresponding detection results.

In this disclosure, when the total number of points in the target point cloud data does not exceed the maximum point limit, sampling is not performed. Instead, a pseudo-image is generated from the current target point cloud data, and corresponding detection results are obtained.

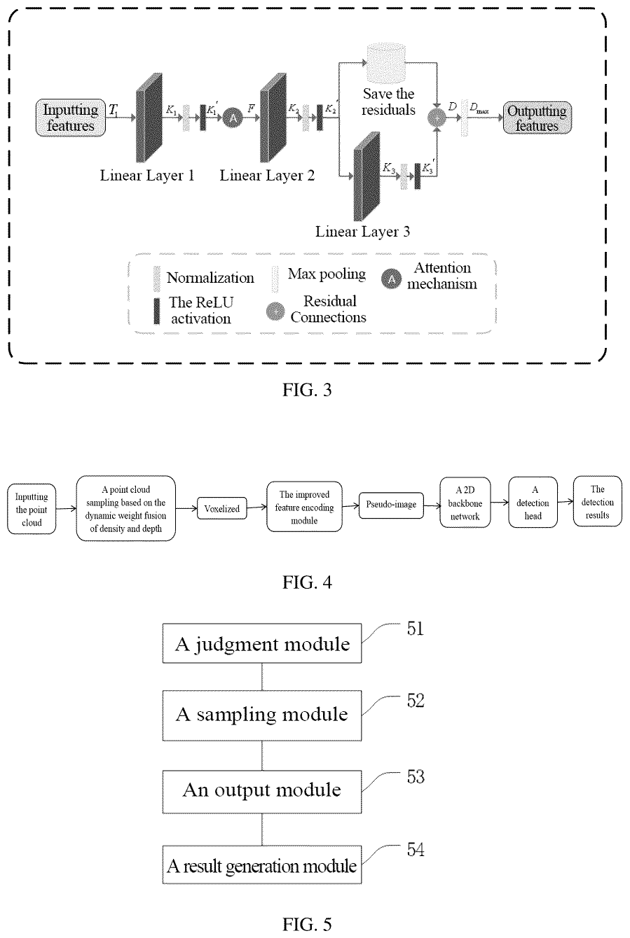

Furthermore, as shown in FIG. 4, it illustrates an implementation process of the present disclosure. Specifically, after acquiring the point cloud, the target point cloud data is sampled using a point cloud sampling method based on the dynamic weight fusion of density and depth. Subsequently, the sampling results are voxelized and input into the improved feature encoding module. Based on the corresponding output target tensor, a pseudo-image is generated. Then, a 2D backbone network, namely a two-dimensional convolutional neural network, along with a detection head, is employed to output the detection results.

In this disclosure, the effectiveness of the disclosure is also validated. Based on the OpenPCDet (a 3D object detection codebase) framework, the KITTI dataset is used for testing. The test dataset comprises 7,481 training samples and 7,518 test samples, with the training samples further divided into 3,712 training sets and 3,769 validation sets. The corresponding maximum point limit is set to 16,384. During testing, only the laser radar point cloud data from the training set is used for training and validation across three categories: cars, pedestrians, and bicycles. The evaluation of object detection is based on the size of the objects, truncation conditions, and occlusion status, categorized into three difficulty levels: easy, moderate, and hard. The detection results for each category are evaluated using AP (Average Precision), and the mean AP value for the moderate difficulty level across the three categories, i.e., mAP (Mean Average Precision), is used as a comprehensive performance metric for the model. The corresponding methods employed are F-PointNets (Frustum PointNets), AVOD-FPN (an Aggregate View Object Detection network with Feature Pyramid), SECOND (Sparsely Embedded Convolutional Detection), PointRCNN, VoxelNet, PointPillars, and the method corresponding to this disclosure.

Training and evaluation are conducted within the PyTorch (a framework for machine learning and deep learning) framework, with a hardware environment consisting of 4 NVIDIA 4090 GPUS and an Intel Xeon Gold 6226R CPU. The network is trained for 90 epochs, with a batch size set to 8. The optimizer chosen is Adam, with an initial learning rate of 0.003.

Tables 1 and 2 respectively present the evaluation results of this disclosure in 3D object detection tasks and BEV (Bird's Eye View) detection tasks, and compare them with existing object detection algorithms. The results indicate that the method corresponding to this disclosure significantly enhances performance, with the mAP value increasing from 60.58% to 63.76%. Particularly in pedestrian 3D object detection, the detection performance at each difficulty level improves by 4.01%, 4.48%, and 4.37%, respectively.

TABLE 1
Results of testing on the 3D detection benchmark:

| | | Mean | | | | | | | | | |
|---|---|---|---|---|---|---|---|---|---|---|---|
| | | Average | | | | | | | | | |
| | | Precision | Automobile | | | Pedestrian | | | Bicycle | | |
| Method | Data Type | Moderate | Easy | Moderate | Hard | Easy | Moderate | Hard | Easy | Moderate | Hard |
| F-PointNet | Point | 57.35 | 81.20 | 70.39 | 62.19 | 51.21 | 44.89 | 40.23 | 71.96 | 56.77 | 50.39 |
| | Cloud + Image | | | | | | | | | | |
| AVOD-FPN | Point | 55.62 | 81.94 | 71.88 | 66.38 | 50.80 | 42.81 | 40.88 | 64.00 | 52.18 | 46.61 |
| | Cloud + Image | | | | | | | | | | |
| PointRCNN | Point Cloud | 59.05 | 85.94 | 75.76 | 68.32 | 49.43 | 41.78 | 38.63 | 73.93 | 59.60 | 53.59 |
| VoxelNet | Point Cloud | 49.05 | 77.47 | 65.11 | 57.73 | 39.48 | 33.69 | 31.5 | 61.22 | 48.36 | 44.37 |
| SECOND | Point Cloud | 56.69 | 83.13 | 73.66 | 66.20 | 51.07 | 42.56 | 37.29 | 70.51 | 53.85 | 46.90 |
| PointPillars | Point Cloud | 60.58 | 85.07 | 75.86 | 71.76 | 52.04 | 45.82 | 41.81 | 77.00 | 60.05 | 57.30 |
| This Method | Point Cloud | 63.76 | 86.09 | 76.39 | 72.30 | 56.05 | 50.30 | 46.18 | 80.25 | 64.60 | 60.41 |

TABLE 2
Results of testing on the BEV detection benchmark:

| | | Mean | | | | | | | | | |
|---|---|---|---|---|---|---|---|---|---|---|---|
| | | Average | | | | | | | | | |
| | | Precision | Automobile | | | Pedestrian | | | Bicycle | | |
| Method | Data Type | Moderate | Easy | Moderate | Hard | Easy | Moderate | Hard | Easy | Moderate | Hard |
| F-PointNet | Point | 65.39 | 88.70 | 84.00 | 75.33 | 58.09 | 50.22 | 47.20 | 75.38 | 61.96 | 54.68 |
| | Cloud + Image | | | | | | | | | | |
| AVOD-FPN | Point | 64.11 | 88.53 | 83.79 | 77.90 | 58.57 | 51.05 | 47.54 | 68.06 | 57.48 | 50.77 |
| | Cloud + Image | | | | | | | | | | |
| PointRCNN | Point Cloud | 65.92 | 89.13 | 85.39 | 80.72 | 53.77 | 45.13 | 41.84 | 82.56 | 67.24 | 60.28 |
| VoxelNet | Point Cloud | 58.25 | 89.35 | 79.26 | 77.39 | 46.13 | 40.74 | 38.11 | 66.70 | 54.76 | 50.55 |
| SECOND | Point Cloud | 60.56 | 88.07 | 79.37 | 77.95 | 55.10 | 46.27 | 44.76 | 73.67 | 56.04 | 48.78 |
| PointPillars | Point Cloud | 67.38 | 89.81 | 86.78 | 83.40 | 57.56 | 52.32 | 47.69 | 79.33 | 63.03 | 60.40 |
| This Method | Point Cloud | 70.00 | 90.13 | 87.65 | 85.48 | 60.37 | 55.58 | 51.41 | 82.44 | 66.78 | 63.65 |

This disclosure acquires target point cloud data and determines whether the total number of points in the target point cloud data exceeds a maximum point limit. When the total number of points in the target point cloud data exceeds the maximum point limit, weighted sampling is performed on the target point cloud data using a point cloud sampling method based on the dynamic weight fusion of density and depth, resulting in sampled point cloud data. The sampled point cloud data is then voxelized to obtain voxelized point cloud data, which is processed by an improved feature encoding module to output a target tensor. Based on the target tensor, a pseudo-image is generated, features are extracted from the pseudo-image using a two-dimensional convolutional neural network, and detection and regression are performed on the extracted features using a detection head to obtain detection results. By employing a point cloud sampling method based on the dynamic weight fusion of density and depth, this disclosure dynamically adjusts sampling weights by combining depth information and density distribution of the point cloud, addressing the issue of easily overlooking information in sparse regions in current sampling methods, thereby significantly enhancing the representativeness and processing efficiency of point cloud data. Meanwhile, this disclosure improves the feature encoding module, thereby enhancing the overall algorithm's accuracy and robustness in object recognition and segmentation tasks.

Furthermore, as shown in FIG. 5, based on the aforementioned laser radar object detection method, this disclosure also provides a corresponding laser radar object detection system, wherein the laser radar object detection system comprises:
a judgment module 51 configured to acquire target point cloud data and determine whether the total number of points in the target point cloud data exceeds a maximum point limit;
a sampling module 52 configured to perform weighted sampling on the target point cloud data using a point cloud sampling method based on the dynamic weight fusion of density and depth when the total number of points in the target point cloud data exceeds the maximum point limit, resulting in sampled point cloud data;
an output module 53 configured to voxelize the sampled point cloud data to obtain voxelized point cloud data, process the voxelized point cloud data using an improved feature encoding module, and output a target tensor;
a result generation module 54 configured to generate a pseudo-image based on the target tensor, extract features from the pseudo-image using a two-dimensional convolutional neural network, and perform detection and regression on the extracted features using a detection head to obtain detection results.

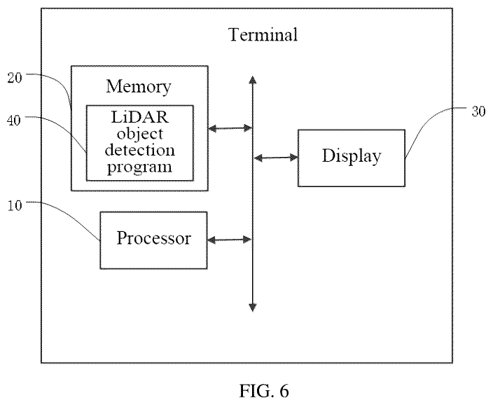

Furthermore, as shown in FIG. 6, based on the aforementioned laser radar object detection method and system, this disclosure also provides a corresponding terminal, which comprises a processor 10, a memory 20, and a display 30. FIG. 6 only shows some components of the terminal, but it should be understood that not all shown components are required, and more or fewer components can be implemented alternatively.

The memory 20 can be an internal storage unit of the terminal in some embodiments, such as a hard drive or memory of the terminal. In other embodiments, the memory 20 can also be an external storage device of the terminal, such as a plug-in hard drive equipped on the terminal, a Smart Media Card (SMC), a Secure Digital (SD) card, a Flash Card, etc. Furthermore, the memory 20 can comprise both internal storage units and external storage devices of the terminal. The memory 20 is used to store application software and various types of data installed on the terminal, such as program codes for the installation terminal. The memory 20 can also be used to temporarily store data that has been output or will be output. In one embodiment, the memory 20 stores a laser radar object detection program 40, which can be executed by the processor 10 to implement the laser radar object detection method of this disclosure.

The processor 10 can be a Central Processing Unit (CPU), a microprocessor, or other data processing chips in some embodiments, configured to run program codes stored in the memory 20 or process data, such as executing the laser radar object detection method.

The display 30 can be an LED display, a liquid crystal display, a touch-sensitive liquid crystal display, or an Organic Light-Emitting Diode (OLED) touch screen, etc., in some embodiments. The display 30 is used to display information on the terminal and to display a visual user interface.

In one embodiment, when the processor 10 executes the laser radar object detection program 40 stored in the memory 20, the steps of the aforementioned laser radar object detection method are implemented.

This disclosure also provides a computer-readable storage medium, wherein the computer-readable storage medium stores a laser radar object detection program, and when the laser radar object detection program is executed by a processor, the steps of the aforementioned laser radar object detection method are implemented.

It should be noted that, in this context, the terms “include,” “comprise,” or any other variants thereof are intended to encompass non-exclusive inclusions, such that a process, method, item, or terminal that includes a series of elements not only includes those elements but also includes other elements not explicitly listed or inherent to such process, method, item, or terminal. Without additional constraints, an element defined by the statement “including one . . . ” does not exclude the presence of additional identical elements in the process, method, item, or terminal that includes that element.

Of course, those skilled in the art can understand that all or part of the processes in the aforementioned embodiments can be accomplished by instructing relevant hardware (such as processors, controllers, etc.) through computer programs, and the programs can be stored in a computer-readable storage medium, such as a memory, magnetic disk, or optical disk, etc. The program, when executed, can comprise the processes of the aforementioned method embodiments. The computer-readable storage medium mentioned herein can be a memory, magnetic disk, optical disk, etc.

It should be understood that the application of this disclosure is not limited to the examples mentioned above, and those skilled in the art can make improvements or variations based on the above description, and all such improvements and variations should fall within the protection scope of the appended claims of this disclosure.

1. A laser radar target detection method, wherein the laser radar targe detection method comprises:
obtaining target point cloud data and determining whether a total number of points in the target point cloud data exceeds a maximum point limit;
performing weighted sampling on the target point cloud data through a point cloud sampling method based on the dynamic weight fusion of density and depth to obtain sampled point cloud data when the total number of points in the target point cloud data exceeds the maximum point limit;
performing voxelization on the sampled point cloud data to obtain voxelized point cloud data, processing the voxelized point cloud data according to an improved feature encoding module, and outputting a target tensor;
generating a pseudo-image according to the target tensor, extracting features from the pseudo-image according to a two-dimensional convolutional neural network, and performing detection and regression on the extracted features using a detection head to obtain detection results.

2. The laser radar targe detection method according to claim 1, wherein performing weighted sampling on the target point cloud data through the point cloud sampling method based on the dynamic weight fusion of density and depth to obtain sampled point cloud data specifically comprises:
calculating depth of each point according to the spatial coordinates of each point in the target point cloud data, and normalizing each depth to obtain a normalized depth value for each point;
calculating a distance threshold according to the depth of each point, and calculating a depth score for each point according to the distance threshold and the normalized depth value of each point;
calculating local density of each point based on k-nearest neighbor algorithm, and calculating a density score for each point according to the local density of each point;
calculating a depth weight and a density weight for each point according to the density score and depth score of each point;
fusing the depth score and density score of each point to obtain a fusion score for each point according to the depth weight and density weight of each point, normalizing the fusion score of each point to obtain a sampling probability for each point;
sampling a number of points equal to the maximum point limit from the target point cloud data to form the sampled point cloud data according to the sampling probability of each point.

3. The laser radar targe detection method according to claim 2, wherein calculating a distance threshold according to the depth of each point, and calculating a depth score for each point according to the distance threshold and the normalized depth value of each point specifically, comprises:
obtaining a maximum depth and a minimum depth among all points according to the depths of all points, and calculating the distance threshold according to the maximum depth and the minimum depth;
determining whether the depth of each point is less than the distance threshold, when it is less, multiplying the normalized depth value of the point by a factor to obtain the depth score of the point;
taking the normalized depth value of the point as the corresponding depth score when the depth of a point is not less than the distance threshold.

4. The laser radar targe detection method according to claim 2, wherein calculating the local density of each point based on the k-nearest neighbor algorithm, and calculating a density score for each point according to the local density of each point specifically, comprises:
calculating the average distance between each point and a preset number of nearest points based on the k-nearest neighbor algorithm to obtain the local density of each point;
obtaining maximum local density and minimum local density among all local densities;
normalizing according to the local density of each point, the maximum local density, and the minimum local density to obtain a density score for each point.

5. The laser radar targe detection method according to claim 1, wherein processing the voxelized point cloud data according to the improved feature encoding module and outputting a target tensor specifically, comprises:
the feature encoding module centralizing each point according to the voxelized point cloud data to obtain centralized point coordinates and voxel centroid coordinates;
calculating the covariance matrix of the point cloud in each voxel according to the voxel centroid coordinates and each centralized point coordinate, and performing eigenvalue decomposition on each covariance matrix to obtain an eigenvector of each covariance matrix;
obtaining a normal vector corresponding to each point according to the eigenvector of each covariance matrix, and generating a three-dimensional tensor according to the normal vector of each point and the voxelized point cloud data;
inputting the three-dimensional tensor into a point cloud feature enhancement module based on a self-attention mechanism for linear transformation to obtain and output a target tensor.

6. The laser radar targe detection method according to claim 5, wherein inputting the three-dimensional tensor into the point cloud feature enhancement module based on a self-attention mechanism for linear transformation to obtain and output a target tensor specifically, comprises:
the point cloud feature enhancement module based on a self-attention mechanism performing three linear transformations on the three-dimensional tensor, and performing residual connection on results of a second transformation and a third linear transformation to obtain linear features, wherein normalization is performed after each linear transformation, and non-linearity is introduced according to an activation function to obtain a result of the linear transformation, a result of the first linear transformation is configured as an input of the second linear transformation after passing through the self-attention mechanism, and a result of the second linear transformation is configured as an input of the third linear transformation;
obtaining a maximum value among the linear features, and taking the maximum value among the linear features as the target tensor and outputting the maximum value.

7. The laser radar targe detection method according to claim 1, wherein after obtaining target point cloud data and determining whether the total number of points in the target point cloud data exceeds the maximum point limit, further comprising:
when the total number of points in the target point cloud data does not exceed the maximum point limit, performing voxelization on the current sampled point cloud data to obtain the voxelized point cloud data at this time, processing the corresponding voxelized point cloud data according to the improved feature encoding module, and outputting a corresponding target tensor;
extracting features from a current target tensor according to a two-dimensional convolutional neural network, and performing detection and regression on the extracted features using a detection head to obtain corresponding detection results.

8. A laser radar targe detection system, wherein the laser radar targe detection system comprises:
a judgment module, configured to obtain target point cloud data and determine whether a total number of points in the target point cloud data exceeds a maximum point limit;
a sampling module, configured to, when the total number of points in the target point cloud data exceeds the maximum point limit, perform weighted sampling on the target point cloud data through a point cloud sampling method based on dynamic weight fusion of density and depth to obtain sampled point cloud data;
an output module, configured to perform voxelization on the sampled point cloud data to obtain voxelized point cloud data, process the voxelized point cloud data according to an improved feature encoding module, and output a target tensor;
a result generation module, configured to generate a pseudo-image according to the target tensor, extract features from the pseudo-image according to a two-dimensional convolutional neural network, and perform detection and regression on the extracted features using a detection head to obtain detection results.

9. A terminal, wherein the terminal comprises: a memory, a processor, and a laser radar targe detection program stored on the memory and runnable on the processor, when the laser radar targe detection program is executed by the processor, the steps of the laser radar targe detection method according to claim 1 are implemented.
